(19) United States
(12) Patent Application Publication
(10) Pub. No.: US 2005/0027736 A1
(43) Pub. Date: Feb. 3, 2005

(54) Grouping of objects in object-oriented system

(75) Inventor: Lauri Kalima, Espoo (FI)

Correspondence Address: YOUNG & THOMPSON, 745 SOUTH 23RD STREET, 2ND FLOOR, ARLINGTON, VA, 22202, US

(73) Assignee: NOLICS OY, HELSINKI (FI)

(21) Appl. No.: 10/895,889

(22) Filed: Jul. 22, 2004

(30) Foreign Application Priority Data
Jul. 28, 2003 (FI) 20031107

(51) Int. Cl. G06F 7/00

(52) U.S. Cl. 707/103 R

(57) ABSTRACT

The invention relates to a method for handling a group of objects at run-time in an object-oriented system. The method marks (1200) beforehand object pointers between different objects of the object group with a group definition identifying the group, and handles (1201-1204) the objects of the object group iteratively at run-time by beginning from one first object of the object group and traversing the object pointers comprising said group definition from one object to another.

The invention relates to grouping and handling of objects in an object-oriented system.

Object-oriented systems usually model dependencies by means of pointers. This means that, for example, in a one-to-many interdependence, a parent object has an object pointer to each child object. Respectively, a child object has a pointer back to the parent object. Also other structures are in use, for example, different intermediate objects may be used.

In addition to interdependencies, objects form logical groups. One may say, for example, that a certain order-type object and order-line-type objects related to it form a group. Another certain order-type object, order-line-type objects related to it, and product-type objects related to the order lines may form another group.

In known methods, grouping of objects is performed manually. For example, when one wants to transfer certain data content comprised of many objects out of a system, or one wants otherwise to handle this data content as a whole, a programmer writes a routine which includes hard-coded instructions to examine all objects which belong to this data content. An example of this kind of data content might be the handling of a certain order and order lines related to it, in which handling one wants to examine this data content, for example, for transferring into another system.

Such routine is, however, laborious to write, and all the changes into a grouping done this way are laborious to make. Furthermore, a routine written for one purpose cannot usually be utilised in the handling of another kind of data content. The handling of object groups is the harder the more complex an application is in question, for example, the application of product-configurator-type technical calculation may involve dozens or hundreds of different types of objects, and thus examining objects and forming groups with manual programming work is quite laborious.

The different types of groupings of the same objects add another level of complexity, as link traversal must be conditionalised based on whether the object pointed by the link belongs to the grouping to be traversed or not.

Furthermore, examining objects and forming groups by means of manual programming work is, strictly interpreted, against the rules of object-oriented programming, as it assumes that objects have a certain internal structure, and is thus against the encapsulation principle of object-oriented programming.

If one does not wish to breach the encapsulation principle of object-oriented programming, a walkthrough method may be set to each base class of objects to be examined. A solution according to this method is difficult to implement in complex inheritance chains, because one must write their own walkthrough methods for object pointers missing from the base class of inherited classes. When using this method, the actual walkthrough routine is scattered in methods in different objects and is thus hard to maintain. Possible cyclic nature of interdependencies and/or the use of bidirectional object pointers causes additional problems, because then all objects must be aware of which other objects have already been examined. A solution to the cyclicity problem is to pass the examined objects or a list to the examined objects in method invocations, but this solution is both cumbersome and prone to errors. Error-proneness is caused by the fact, for example, that a check on if the object pointed by the object pointer has already been handled must be added to each walkthrough method.

The different types of groupings of the same objects are also problematic in this solution. The methods must be hard-coded with options to traverse different kinds of links depending on whether the object being the target of the link belongs to the desired type of grouping or not.

A typical situation in which above-mentioned problems arise is serialisation of objects. Serialisation means transforming objects into serial form when the objects are written to a data stream. An example of this is an object-oriented order system in which one wants to serialise all the data related to the order, possibly for transferring into another system.

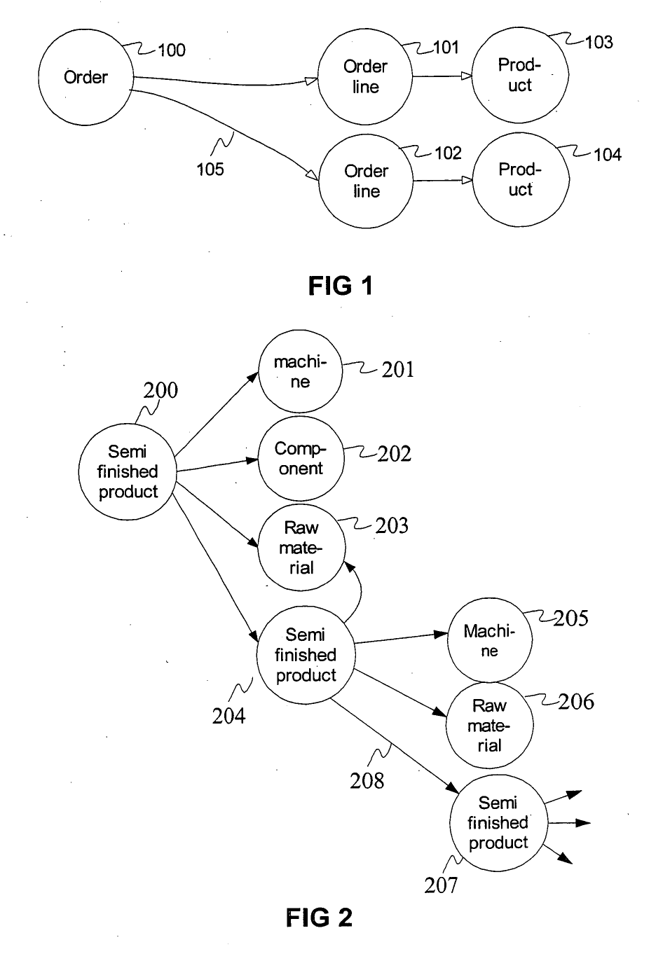

FIG. 1 is a graph, which illustrates interdependencies of objects in connection with an example related to an order system. The illustrated structure comprises an order-type object 100, two order-line-type objects 101 and 102 related to the order-type object, and, respectively, two product-type objects 103 and 104 related to order lines 101 and 102. The arrows in the figure illustrate object pointers between objects, for example, arrow 105 between the order and the order line illustrates that from order-type object 100 there is an object pointer to the order-line-type object 102.

Generally, the above-mentioned problems occur in any application area when one wants to handle all objects belonging to a certain data content, linked to each other. As an application example, one may present, inter alia, an object-oriented product data system in which hierarchically structured objects define components of the product and configurations with which the product will be manufactured. Examining objects has to be performed when, for example, one wants to calculate the sum of the weight fields, weighed by the quantity, of all objects related to the product structure.

FIGS. 2-4 are graphs, which illustrate interdependencies of objects in a hierarchical product structure. The product structure of FIG. 2 comprises a semi-finished-type object 200, which in turn comprises a work phase performed with a machine-type object 201 modelling a machine, a component-type object 202, a raw-material-type object 203, and the earlier manufactured semi-finished-type object 204.

Respectively, the semi-finished-type object 204 comprises a work phase performed with a machine-type object 205 modelling a machine, raw-material-type objects 203 and 206, and the earlier manufactured semi-finished-type object 207.

Thus, in the example, the same raw-material-type object 203 is used in manufacturing both the semi-finished-type object 200 and semi-finished-type object 204. The arrows in the figure describe object pointers between objects, for example, arrow 208 describes that from the semi-finished-type object 204 there is an object pointer to the semi-finished-type object 207.

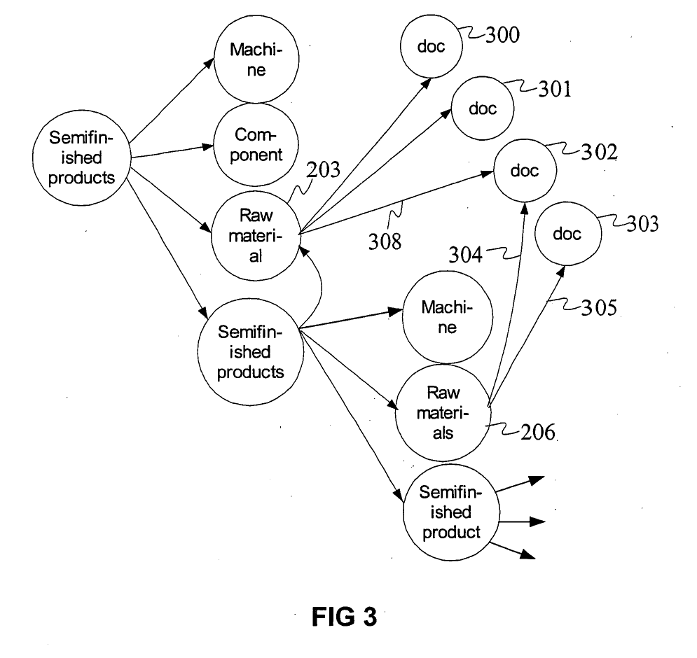

In addition, the product structure may include documents, and the same document may relate to several elements, such as raw material. Then different objects may have a different number of document links, for example, a certain type of raw material or component may have three document links, whereas a component of another type has only one document link. FIG. 3 shows a graph similar to FIG. 2 into which such document-type objects 300, 301, 302 and 303 have been added. The arrows illustrate object pointers between objects, for example, arrow 305 illustrates that from a raw-material-type object 206 there is an object pointer to a document-type object 303. The document-type object 302 is related to both raw-material-type object 206 and raw-material-type object 203, which association is expressed with pointers 304 and 308.

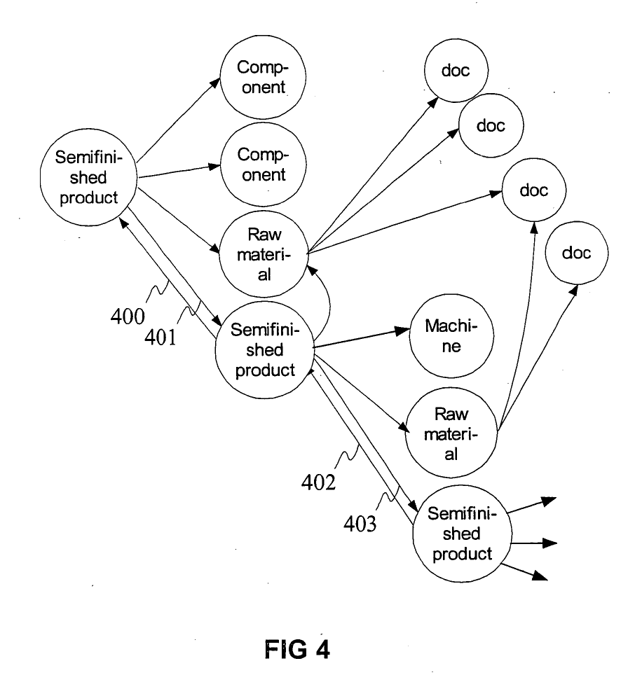

Dependencies in object model are mostly modeled in practical applications as bidirectional links in order to the handling to be efficient. FIG. 4 shows bidirectional links according to this modeling method in a structure similar to the one in FIG. 3. The figure shows bidirectional links 400 and 401, and 402 and 403 only between semi-finished-type objects, but also other shown links may be, respectively, bidirectional.

It is possible that, in product design, one wants to serialise a whole product structure, for example, for storing the product structure on a disk for transferring into another system. Then one should examine all objects forming a product, but each only once. In one grouping, one may want to transfer only the product but not the documents related to it. In another grouping, one may, in turn, want to make a list of raw materials and components included in the product. If there are many ways of grouping, one must do a lot of manual programming work for each different grouping.

The problem becomes more complex, if the products of FIG. 1 are the semi-finished products shown in FIG. 4. Then, for example, an order may be related to many different summaries (an order with its order lines, an order with its order lines itemised, documents of products related to an order etc.) for each of which one must do a lot of manual and error-prone programming work.

Now an invention has been made an objective of which is to solve the above-mentioned problems, or, at least, to minimise the disadvantages related to them by implementing a new method for handling a group of objects at run-time in an object-oriented system.

According to a first aspect of the invention, a method is implemented for handling a group of objects at run-time in an object-oriented system, the method comprising
marking beforehand object pointers between different objects with a group definition identifying the group, and
handling objects of the object group iteratively at run-time by means of the group definition by beginning from one first object of the object group and traversing the object pointers comprising said group definition from one object to another.

Said iterative handling may comprise the following steps:
searching said first object for object pointers comprising said group definition,
examining if the object pointed by the object pointer comprising the group definition has already been handled, and handling the pointed object in a way corresponding to said first object if the pointed object has not been handled yet, and
continuing said iterative handling until the objects pointed by the object pointers comprising said group definition have been handled.

For marking with a group definition, one may use programming language attributes, an attribute being an instrument with which, in design phase, one may attach one or more markings to an object pointer, which marking may be examined at run-time.

Said iterative handling may be performed, for example, in an iterator structure to which one gives, as a parameter, said group definition and one object from which iteration is begun. Said iterator structure may be generic and independent of object groups to be handled, and one may examine in said iterator structure which of the data members in the object to be handled are object pointers by utilising reflection.

The objects of the object group to be handled may belong to the same class or to different classes.

According to a second aspect of the invention, a computer program is implemented comprising a routine for handling an object group at run-time in an object-oriented system, the object pointers between different objects of the object group being marked beforehand with a group definition defining the group, said computer program implementing the following steps when running said computer program in a computer:
handling objects of the object group iteratively at run-time by means of the group definition by beginning from one first object of the object group and traversing the object pointers comprising said group definition from one object to another.

According to a third aspect of the invention, a data processing device is implemented for handling an object group at run-time in an object-oriented system, the object pointers between different objects of the object group being marked beforehand with a group definition identifying a group, said data processing device comprising:
equipment for handling objects of the object group iteratively at run-time by means of the group definition by beginning from one first object of the object group and traversing the object pointers comprising said group definition from one object to another.

The dependent claims concern embodiments of the invention. The contents of the dependent claims related to one aspect of the invention may also be applied to the other aspects of the invention.

The invention will now be described in detail by way of examples with reference to the accompanying figures, in which

FIG. 1 is a graph, which illustrates interdependencies of objects in connection with an example related to an order system;

FIGS. 2-4 are graphs, which illustrate interdependencies of objects in a hierarchical product structure;

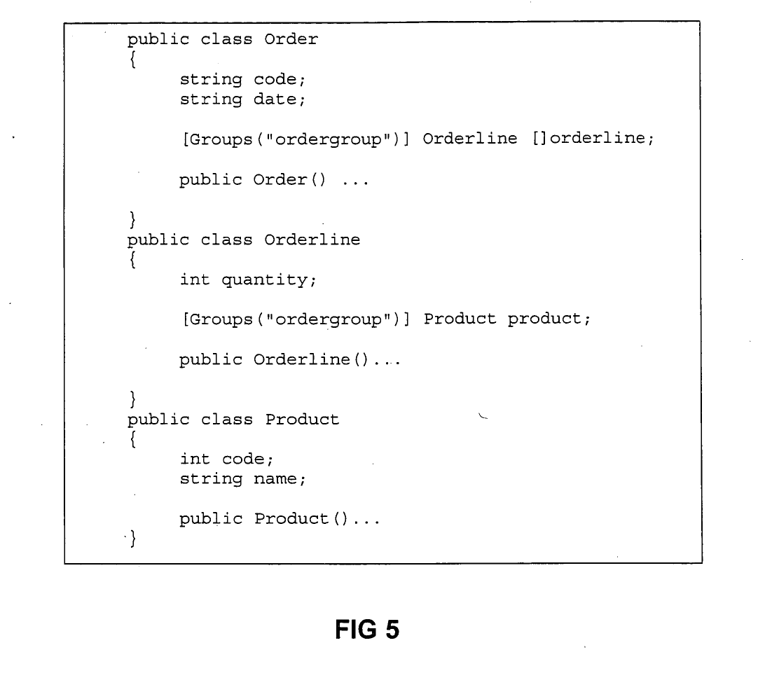

FIG. 5 shows a class definition according to an embodiment of the invention with a programming language;

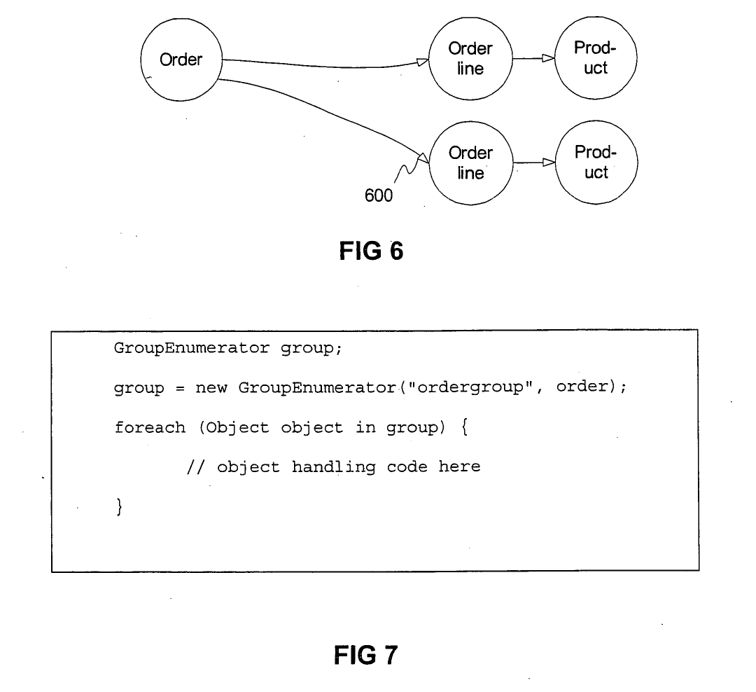

FIG. 6 shows an instance of a graph formed from the class definition of FIG. 5;

FIG. 7 is a code example for examining class definitions by means of a programming language;

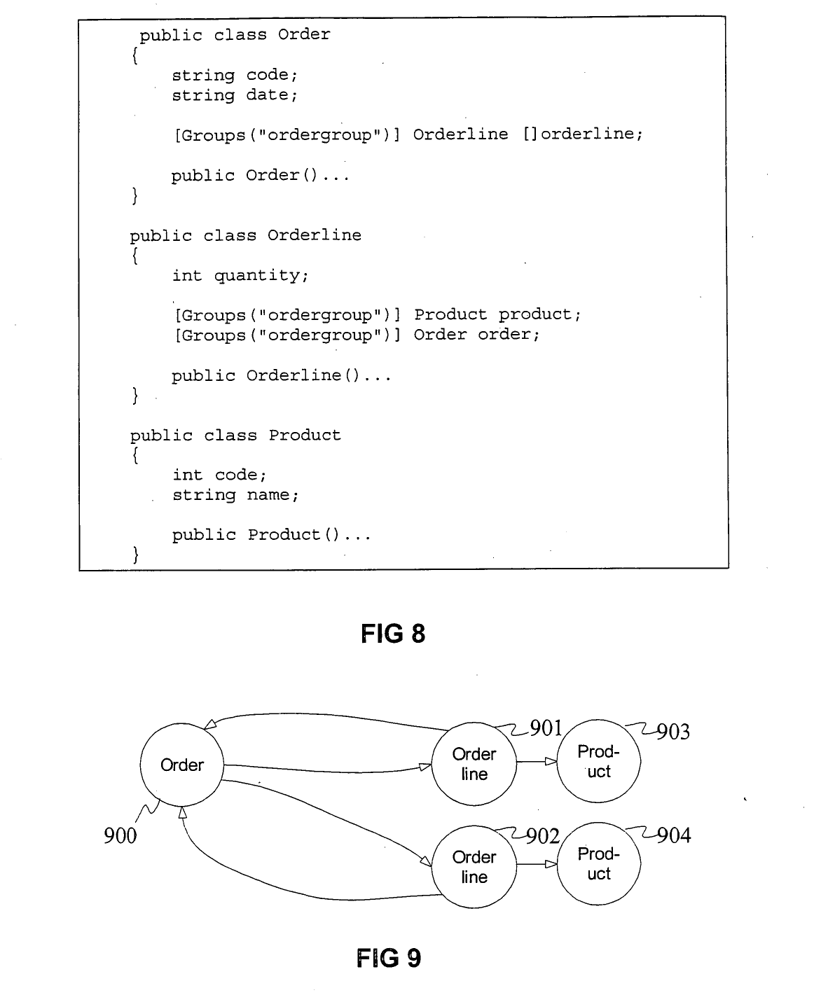

FIG. 8 shows a class definition according to a second embodiment of the invention with a programming language;

FIG. 9 shows an instance of a graph formed from the class definitions of FIG. 8;

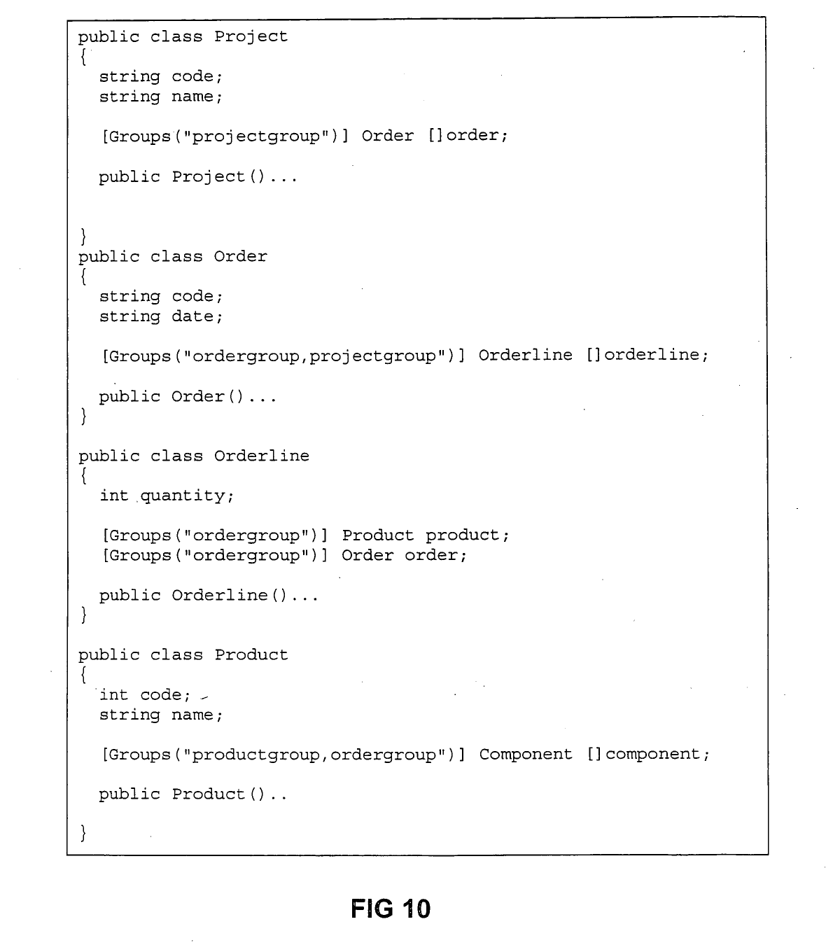

FIG. 10 shows a class definition according to a further embodiment of the invention with a programming language;

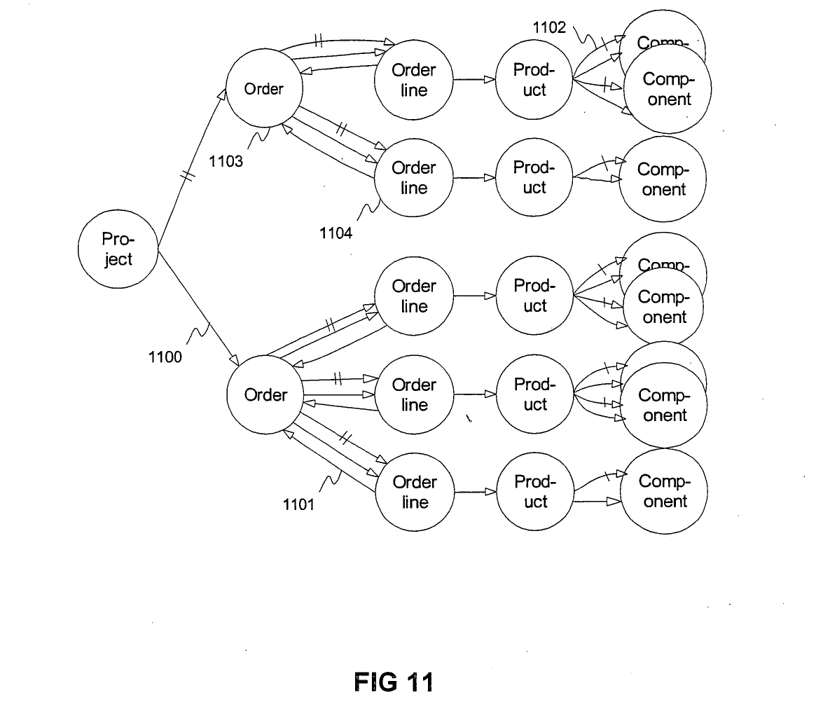

FIG. 11 shows instances of graphs formed from the class definitions of FIG. 10;

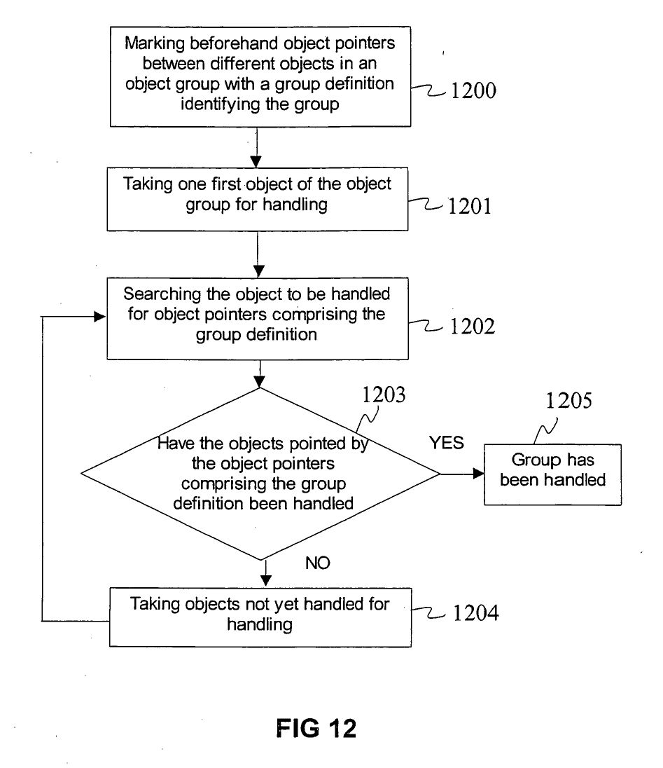

FIG. 12 is a flow diagram illustrating a method according to an embodiment of the invention; and

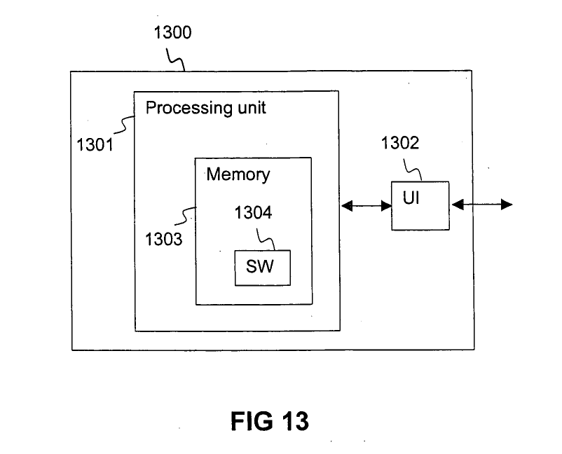

FIG. 13 shows a data processing device according to an embodiment of the invention.

FIGS. 1-4 were discussed above in connection with the description of known prior art.

One basic idea of the invention is to mark links which associate objects belonging to a group with a group definition, and to examine the objects of the object group iteratively at run-time by means of the group definition beginning from one first object of the object group and traversing the object pointers comprising said group definition from one object to another. Thus, the group forms a directional graph during handling. Depending on from which object the handling begins, the graph in question may have different instances.

An embodiment of the invention is based on two relatively new concepts of programming language, attributes and reflection. A programming language which supports these concepts is Microsoft's C#, but also other languages supporting reflection and attributes may be utilised in implementing the invention.

By means of reflection, the type data of object member variables is available at run-time. According to an embodiment of the invention, by means of reflection, one searches the data members included in the object for object pointers at run-time. Instead of the reflection feature, the invention may be implemented with some other method with which one may examine at run-time which of the data members included in the object are of object-pointer-type.

In this context, attributes mean such attributes with which, in addition to other features, one may attach additional markings in member variables in the planning phase of the program, these additional markings being available at run-time. According to an embodiment of the invention, attributes implement marking with a group definition. The implementation manner of attributes and their other uses are internal matters of the programming language and may vary depending on the programming language, but do not affect the implementation of the invention, so they are not dealt with here in more detail.

The invention may also be utilised so that, instead of attribute marking, the group definitions come from an external source, for example, from an XML (eXtensible Markup Language) file. Without limiting the invention in any way, a solution based on attributes is presented below as an example of implementation. However, any other applicable marking method may also be used in connection of the invention.

Thus, a basic idea of the invention is to mark links associating objects belonging to a group with attributes. Attributes define one or more virtually directed graphs which associate objects to each other with unidirectional links. One object set defined by a graph is called a group. A certain type of graph and a group defined by it have many instances. If, for example, an order-type object and its order-line-type objects belong to a certain group, one gets a different instance of graph and group depending on from which order-type object one begins.

A second basic idea of the invention relates to an iterator structure, which is used in examining the group members defined by an instance of a virtual graph. For examining, the iterator structure is given an object for a root object and the group definition of a desired group. Generic iterator routine utilises reflection in order to determine which data members of the root object are object pointers. Based on link attributes and thus on the object pointed by the object pointer belonging to the group and on the link being already examined, the iterator deduces if the link should be traversed or not. The iterator structure examines respectively all objects in the group.

Next, the invention is explained by means of examples related to orders and product structures. The application area in which the invention is applied may, however, be any object-oriented system, which comprises links between objects and in which the objects need to be handled in groups. In an applicable system, the same object may belong to one or more groups.

FIG. 5 shows a class definition according to an embodiment of the invention with Microsoft's C# language. Microsoft's C# language is used as an example in this and other code examples, but also other programming languages supporting attribute marking and reflection described above may be used in exploiting the invention. In the figure, three dots ( . . . ) describe those members of an object, which are not relevant to the invention.

The illustrated class definition defines an order-type object and an array of object pointers, which point to order lines. A way of marking object pointers by means of attributes according to an embodiment of the invention is included in the class definition.

In the figure, attributes (the definition “Groups” in the class Order) mark that the objects pointed by the object pointers of the array pointing to the order-line-type objects of the order belong to a group named “ordergroup”. Respectively, attributes (the definition “Groups” in the class Orderline) mark that objects pointed by an object pointer pointing to product-type objects of the order line belong to a group named “ordergroup”.

The syntax of attribute marking is not relevant to the invention. In the example, the syntax is composed of keyword “Groups” and group-name-type parameters given to it. Depending on used programming language, the syntax may be of some other type. It is essential that one can mark the object pointer with a marking of attribute-like behaviour, and that one can mark the same object pointer with many different markings.

FIG. 6 shows an instance of a graph formed from the class definition of FIG. 5. The shown graph is formed when beginning from a certain order-type object and from the group definition “ordergroup”. In the example, this order-type object is related with two order-line-type objects. In FIG. 6, open-headed arrows 600 are used to distinguish the arrows describing the graph from the black-headed arrows of object pointers used in earlier figures. In this case, as only one group has been defined and all object pointers are marked with this same group definition, the figure illustrating the graph is similar to FIG. 1, which describes object pointers.

When an iterator is given as a parameter this certain order-type object and the group definition “ordergroup”, the iterator examines this order-type object and order-line-type objects related to it and respective product-type objects.

FIG. 7 is a code example for examining class definitions by means of Microsoft's C# language. In this example, an array-like object is created for the iterator structure, and the object in question is given in the creation phase as parameter the group definition “ordergroup” and an order-type object. In the example of the figure, the iterator structure is implemented so that the objects belonging to the instance of a formed group are examined when creating the instance of the iterator structure, and thus produced array or collection is examined after this by means of for each structure. The created array-like object is thus filled with object pointers pointing to objects belonging to the group instance before the actual examination of objects belonging to the group instance. Also other implementations may be used in the iterator structure. For example, objects belonging to the group instance may be sorted out when examining objects.

If the iterator structure shown in FIG. 7 is further given an order group as a parameter, but the other parameter is chosen to be another order-type object, a different set of order lines and respective product-type objects is obtained.

One must notice that any type of objects may be given as the iterator parameter.

When an iterator is given as a parameter either one of the order-line-type objects of FIG. 6, the iterator examines only the given order-line-type object and the product-type object related to it.

FIG. 8 shows a class definition according to a second embodiment of the invention with Microsoft's C# language. In the shown definition, a cyclic graph is defined by means of attributes.

FIG. 9 shows an instance of a graph formed from the class definition of FIG. 8.

In the case of the example of FIGS. 8 and 9, when the root object is chosen to be an order-type object and the group parameter is “ordergroup”, the iterator examines order-type object 900, order-line-type objects 901 and 902 related to it, and respective product-type objects 903 and 904. One must notice that because of the cyclic nature of the graph, the exact same set of objects would be received even though the root object was chosen to be, instead of the order-type object 900 in question, either one of the order-line-type objects 901 or 902.

The iterator algorithm is simple to implement so that it examines the objects belonging to the group once, but only once, so that the cyclic nature of the graph does not become a problem when utilising technique according to the invention. When going through the objects, the iterator checks if the same object was already examined, and ignores the objects already examined. Any suitable method may be used in marking the examined objects. An iterator according to the invention may be implemented as one centralised component, so one need not scatter the iterator logic among object structures in different walkthrough methods, as one has to do in some known prior-art solutions.

FIG. 10 shows a class definition according to a further embodiment of the invention with Microsoft's C# language. The definition comprises three group definitions. To the group instance of type “projectgroup” belongs some project-type object, all order-type objects belonging to this project-type object, and order-line-type objects belonging to all these order-type objects, but not the product-type objects referred by order lines. There are many group instances of type “projectgroup” in the system, one for each project-type object.

FIG. 11 shows some instances of graphs formed from the class definitions of FIG. 10. A graph describing the group instance of projectgroup is marked in the figure with a line with two cross-lines 1100. The graphs describing the group instance of ordergroup are marked with a solid line 1101. The graphs describing the group instance of productgroup are marked with a line with one cross-line 1102. Some of these graphs are created utilising the same object pointers, as the same object pointer in the definitions of FIG. 10 is marked with several group definitions. For example, only one object pointer points from an order 1103 to an order-line-type object 1104, but the same order-type object 1103 and order-line-type object 1104 may belong to an instance of several different graphs: in the example of the figure, to the group instance of projectgroup and the group instance of ordergroup.

The group definition projectgroup is acyclic and it is used, for example, when one wants to examine all project-related orders with their order lines, but not the products or components composing the product related to order lines.

One must notice that in FIG. 10 the group of ordergroup of FIGS. 5 and 8 was extended to include product-type objects and component-type objects related to them (the class descriptions of component-type objects are not marked in FIG. 10); FIG. 11 describes some instances of groups so produced. If either an order-type object or an order-line-type object was given to the iterator as the root object parameter, the iterator would examine the whole order with its order lines and the products and product components related to the order lines.

FIG. 12 is a flow diagram illustrating a method according to an embodiment of the invention. In step 1200, the object pointers between different objects of an object group are marked beforehand with a group definition identifying the group in question, for example, with attributes of a programming language. Step 1200 is thus performed in the design phase, before running the program.

Steps 1201-1205 relate to the run of the program at run-time. In step 1201, one takes for handling one first object of the object group, which object may be any object. The object in question is handled by searching it for object pointers comprising the group definition related to the desired group in step 1202. (One must notice that if no such object pointers are found, the handling ends here, even though this is not shown in the flow diagram.) In step 1203, one examines if the objects pointed by the object pointers comprising the group definition are already handled. If this is not the case, one examines those from the objects pointed in step 1204 which have not already been handled, and returns to step 1202. Thus, one examines all objects that are found by traversing the object pointers comprising the group definition, until one comes to a situation in which, at each branch, the objects pointed by object pointers comprising the group definition were handled in step 1203. Then the group is verified as having been handled in step 1205.

FIG. 13 shows a data processing device 1300 according to an embodiment of the invention which data processing device may, for example, be any general-purpose computer or server or other suitable device.

The data processing device 1300 comprises a processing unit 1301 and a user interface (UI) 1302 communicating with it. The user interface 1302 comprises typically a display and a keyboard and possibly another control device (not shown) by means of which the data processing device in question may be used. The invention may also be utilised in devices, which do not have an actual user interface.

Processing unit 1301 comprises a processor (not shown), a memory 1303 and an object-oriented computer program 1304 stored into the memory to be run in said processor. In an arrangement, in which object pointers between different objects of the object group are marked beforehand, in the design phase of said object-oriented computer program 1304, with a group definition identifying the group in question, the processor directs according to computer program 1304 the data processing device to handle the objects of the object group iteratively at run-time by means of the group definition beginning from one first object of the object group and traversing the object pointers comprising said group definition from one object to another.

The inventive basic idea presented here may be applied in many ways in efficient design and implementation of object-oriented software. It is well known by those skilled in the art that this invention may be used for many different purposes, for in many object-oriented applications there exist interdependencies of objects, and one wants to handle objects as groups. An example of this kind of handling is the copying, removal or other aggregate handling of objects of different or similar types related to each other. In addition to the ones mentioned above, evident application areas are, for example, forming XML files or similar files from object-oriented data content.

The invention was described above in connection with advantageous embodiments without limiting the invention to these examples only. The implementation and utilising possibilities of the invention are limited solely by the appended patent claims. Thus, the different implementation alternatives of the invention defined by the claims, also equivalent implementations, are within the scope of the invention.

1. A method for handling a group of objects at run-time in an object-oriented system, wherein the method comprises
marking beforehand object pointers between different objects with a group definition identifying the group, and
handling objects of the object group iteratively at run-time by means of the group definition by beginning from one first object of the object group and traversing the object pointers comprising said group definition from one object to another.

2. A method according to claim 1, wherein said iterative handling comprises the following steps:
searching said first object for object pointers comprising said group definition,
examining if the object pointed by the object pointer comprising the group definition has already been handled, and handling the pointed object in a way corresponding to said first object if the pointed object has not been handled yet, and
continuing said iterative handling until the objects pointed by the object pointers comprising said group definition have been handled.

3. A method according to claim 1, wherein attributes of a programming language are used for marking with a group definition, an attribute being an instrument with which, in design phase, one or more markings may be attached to an object pointer, which marking may be examined at run-time.

4. A method according to claim 1, wherein said iterative handling is performed in an iterator structure with which is given, as a parameter, said group definition and one object from which iteration is begun.

5. A method according to claim 4, wherein said iterator structure is generic and independent of object groups to be handled, and in said iterator structure
it is defined which data members of the object to be handled are object pointers by utilising reflection.

6. A method according to claim 1, wherein the objects of the object group belong to the same class.

7. A method according to claim 1, wherein the objects of the object group belong to different classes.

8. A computer program comprising a routine for handling an object group at run-time in an object-oriented system, object pointers between different objects of the object group being marked beforehand with a group definition identifying the group, said computer program implementing the following steps when running said computer program in a computer:
handling objects of the object group iteratively at run-time by means of the group definition by beginning from one first object of the object group and traversing the object pointers comprising said group definition from one object to another.

9. A computer program according to claim 8, wherein said iterative handling comprises the following steps:
searching said first object for object pointers comprising said group definition,
examining if the object pointed by the object pointer comprising the group definition has already been handled, and handling the pointed object in a way corresponding to said first object if the pointed object has not been handled yet, and
continuing said iterative handling until the objects pointed by the object pointers comprising said group definition have been handled.

10. A data processing device for handling an object group at run-time in an object-oriented system, object pointers between different objects of the object group being marked beforehand with a group definition identifying a group, said data processing device comprising:
equipment for handling objects of the object group iteratively at run-time by means of the group definition by beginning from one first object of the object group and traversing the object pointers comprising said group definition from one object to another.

11. A data processing device according to claim 10, wherein said equipment is arranged to conduct said iterative handling by
searching said first object for object pointers comprising said group definition,
examining if the object pointed by the object pointer comprising the group definition has already been handled, and handling the pointed object in a way corresponding to said first object if the pointed object has not been handled yet, and
continuing said iterative handling until all the objects pointed by the object pointers comprising said group definition have been handled.

12. A computer program of claim 10 stored on a carrier.
